(19) United States
(12) Patent Application Publication
(10) Pub. No.: US 2022/0166336 A1
(43) Pub. Date: May 26, 2022

(54) WIND ENERGY INSTALLATION HAVING AN INVERTER DEVICE FOR GENERATING AN AC VOLTAGE, AND CORRESPONDING METHOD

(71) Applicant: Wobben Properties GmbH, Aurich (DE)

(72) Inventors: Hans-Günter ECKEL, Rostock (DE); Ingmar KAISER, Rostock (DE)

(21) Appl. No.: 17/600,018

(22) PCT Filed: Apr. 1, 2020
(86) PCT No.: PCT/EP2020/059203

§ 371 Date: Sep. 29, 2021

(30) Foreign Application Priority Data
Apr. 1, 2019 (DE) 10 2019 108 409.1

(51) Int. Cl. H02M 5/458; H02J 3/38; H02M 1/00

(52) U.S. Cl. CPC H02M 5/4585; H02J 2300/28; H02M 1/007; H02J 3/381

(57) ABSTRACT

A method for generating at least one AC voltage using at least one inverter device is provided. The inverter device in each case includes comprises at least one voltage input for applying an input voltage, at least one voltage output for outputting an output voltage and at least one DC voltage intermediate circuit for providing an intermediate circuit voltage. The method includes controlling an AC voltage at the voltage output so as to output a first portion of an input power in the form of useful power, or to receive the input power or a portion thereof, and changing a system voltage of the inverter device such that at least one compensation current flows through at least one load resistor, in order thereby to output a second portion of the input power or the entire input power to the at least one load resistor in the form of excess power.

### BACKGROUND

### Technical Field

The present invention relates to a method for generating at least one AC voltage by way of at least one inverter device. The present invention furthermore also relates to a corresponding inverter device. The present invention additionally also relates to a wind power installation having such an inverter device.

### Description of the Related Art

Wind power installations are known, and these generate electrical energy from wind and feed it into an electricity supply grid. For this purpose, modern wind power installations use in particular what is known as a full converter concept, in which the energy is generated by a generator in the form of AC current, this AC current is rectified and this rectified AC current is then inverted again in order to adapt it to the electricity grid into which it is intended to be fed in terms of frequency, phase and voltage level.

Furthermore, it is nowadays also customary, and also often a requirement of grid operators, that such a wind power installation is able not only to perform infeeding in what is known as grid-parallel operation, but also if necessary to take over support tasks. Such support tasks, intended to electrically support the electricity supply grid, often include a rapid change in the power fed in. This may also mean that the level of the power fed in has to be changed very quickly, specifically in the range of seconds or even in the range of less than one second, the electric power fed in, in particular the active power fed in.

Such sudden power changes are sometimes in this case demanded with such a speed or short response time that the wind power installation is not able to reduce the actual power generation of the generator completely or quickly enough in this time.

In such a case, use is then made of what is known as a chopper resistor, by which the power that the generator has generated but that is no longer intended to be fed into the grid is thermally consumed. The term chopper resistor, as used in the jargon, stems from the fact that this resistor is controlled by way of a chopper circuit, which specifically operates in a manner similar to a pulse width modulation process and is thereby able to control the level of the power dissipated into the chopper resistor. It is thereby also possible not only to reduce the power fed into the electricity supply grid, but also to absorb excess power from the electricity supply grid and to dissipate it into this chopper resistor.

Said chopper circuit is accordingly required for this purpose, this thus forming an additional element for an inverter that may entail corresponding costs.

The German Patent and Trademark Office has searched the following prior art in the priority application relating to the present application: DE 23 49 161 A1, DE 25 21 940 A1, DE 10 2007 003 172 A1, DE 10 2009 017 023 A1 and DE 10 2012 209 903 A1.

### BRIEF SUMMARY

Enabling a rapid power reduction or even rapid consumption of power from the electricity supply grid with as little outlay as possible is provided herein.

A method is provided. This method is intended to generate at least one AC voltage by way of at least one inverter device. The inverter device comprises at least one voltage input for applying an input voltage and one voltage output for outputting an output voltage, and at least one DC voltage intermediate circuit for providing an intermediate circuit voltage. In particular, an AC voltage generated by a generator of a wind power installation may be input at the voltage input and an output voltage may be fed into an electricity supply grid via the voltage output. However, a reverse operating direction may also be considered, for example, and it is in particular proposed for the inverter device to be designed such that the voltage input and voltage output have the same functionality, that is to say are both able to receive an AC voltage and also output one. The DC voltage intermediate circuit is in particular designed such that the voltage input and voltage output are essentially connected internally.

The process comprises multiple steps. According to one step, an AC voltage at the voltage output is controlled so as to output a first portion of an input power in the form of useful power. The AC voltage at the voltage output may also be controlled such that an input power or a portion thereof is received. This means in particular that the AC voltage is controlled with respect to an output current or consumed current such that a power is output or consumed.

It is furthermore proposed for a system voltage of the inverter device to be controlled. Such a system voltage is in this respect an internal voltage, and this system voltage is controlled or changed such that at least one compensation current flows through at least one load resistor, in order thereby to output a second portion of the input power or the entire input power to the at least one load resistor in the form of excess power. The load resistor may also be referred to synonymously as braking resistor. The operation when a compensation current is flowing, that is to say when excess power is output, may be referred to as braking operation.

It has in particular been recognized here that modern inverter devices still have at least one degree of freedom of at least one internal voltage, which may be used to allow a compensation current to flow through a load resistor. This in particular makes it possible to avoid using a chopper circuit, which specifically does not control a system voltage, but rather directly generates a pulsed short-circuit current through a chopper resistor. Instead, a system voltage that is present in any case is changed here such that the compensation current is able to flow.

Such a system voltage may in particular be a differential voltage between multiple DC voltage intermediate circuits of the same inverter device, or else the respective DC voltage of a DC voltage intermediate circuit as such. Differential voltages between multiple voltage inputs or voltage outputs or a combination thereof may however also be considered.

It has thus been recognized that the inverter device as such, through skilled operation, is also able to handle the dissipation of electric power or a portion thereof through at least one load resistor without an additional chopper circuit.

One important aspect is thus also that of not using a chopper circuit, this thus being proposed as a solution. In particular, there is no direct control of the compensation current through pulsed current or voltage control.

It is preferably proposed for the input voltage, the output voltage and/or the intermediate circuit voltage to be changed as system voltage, in particular for at least one DC voltage component to be changed or modulated with respect to a reference potential, in particular earth potential. It may also be considered here for an AC voltage component, having a DC component, to be modulated.

The output voltage is in particular a voltage that is present at an output of the inverter device that is connected to an electrical generator, an electric motor, or an electricity supply grid, or is designed to be connected thereto. The input voltage is in particular a voltage that is present at an input of the inverter device that is connected to an electrical generator, an electric motor, or an electricity supply grid, or is designed to be connected thereto. It has in particular been recognized here that the input voltage, output voltage and/or the intermediate circuit voltage may also be changed such that the functionality of the at least one voltage input and of the at least one voltage output and possibly also of the DC voltage intermediate circuit may remain unchanged. In particular, depending on the embodiment, modulating a DC voltage component may lead to a compensation current in particular in the form of a DC current, without the desired AC voltage signal, in particular three-phase AC voltage signal, being changed with regard to the AC component.

A DC voltage component may in particular be changed or modulated and lead to the compensation current, while at the same time the functionality of outputting a portion of the input power in the form of useful power, specifically in the form of a three-phase signal, or a corresponding consumption of an input power by way of a three-phase AC voltage signal, may remain unchanged.

According to one embodiment, it is proposed for the least one DC voltage intermediate circuit to have at least one of the load resistors with a rectifying device connected in series therewith. The rectifying device is designed in particular as a diode. The DC voltage intermediate circuit in this case has two poles and the at least one load resistor with the rectifying device connected in series therewith thus form a series circuit that is arranged between the two poles.

To this end, it is proposed for the system voltage to be changed such that the direction of the intermediate circuit voltage is reversed, so that the rectifying device becomes conductive therefor, and the at least one compensation current thereby flows through the rectifying device and the at least one load resistor.

The intermediate circuit voltage here thus forms the system voltage that is changed. This change takes place such that, for the purpose of generating the compensation current through the at least one load resistor, the direction of the intermediate circuit voltage is reversed at least briefly, that is to say its polarity is reversed, as it were. As a result of this change in the direction of the intermediate circuit voltage, the rectifying device becomes conductive and the compensation current is then able to flow essentially on the basis of the level of the intermediate circuit voltage and the size of the load resistor. Thus, as long as such a compensation current and thus the outputting of excess power is not desired, the direction of the intermediate circuit voltage is not reversed or turned back, and is then applied to the rectifying device in the reverse direction thereof, so that no compensation current flows.

By virtue of this variant, the excess power is thus able to be output when required, without major component outlay. It may also be controlled in this case in terms of its level by adjusting the level of the intermediate circuit voltage and/or by changing the direction of the intermediate circuit voltage only for in each case one output period, and the length of the output period may then also be used to control the level of the output excess power. In this case, periods in which the direction is reversed and periods in which the direction of the intermediate circuit voltage is not reversed may also alternate, and the ratio of these periods in relation to one another may also control the output excess power. The voltage reversal may thus be performed in a pulsed manner, and the power output may be controlled via a pulse-pause ratio.

It is therefore preferably in particular proposed for the level of the excess power to be controlled by controlling a duration of the voltage reversal, that is to say the duration for which the voltage reversal is present, and/or by controlling a level of the intermediate circuit voltage whose direction is reversed. The two could also be combined in order thereby to obtain a corresponding degree of freedom. Other conditions may in particular also influence a sensible level of the intermediate circuit voltage.

It has in particular been recognized that inverting a DC voltage to give an AC voltage does not require any specific direction of the intermediate circuit voltage. In simple terms, the inversion may be performed based on both a positive and a negative intermediate circuit voltage. Ultimately, it is in any case only a question of defining which direction of the intermediate circuit voltage is considered to be positive and which is considered to be negative. The inverter device may adapt to this by being controlled appropriately. The control of the inverter device may in this case be adjusted without any structural outlay. In particular, no previously known additional chopper circuit is required to control the output of the excess power.

According to one embodiment, it is proposed for at least two inverter devices connected in parallel with one another to be provided and for the at least two inverter devices to be connected via at least one of the load resistors. System voltages of the at least two inverter devices are in this case changed in a manner so differently from one another that at least one compensation current flows between the inverter devices through the at least one load resistor. This is based on the concept here that, in the case of two structurally identical and identically operated inverter devices connected in parallel with one another, the same voltage potential is present at two identical voltage points in each case, and these voltage points, mentioned by way of example, may be electrically connected without a compensation current flowing. To this end, it has now been recognized that these two inverter devices, mentioned by way of example, may however be operated in targeted fashion in a manner so differently that a compensation current may actually flow.

It has in particular been recognized that the inverter devices may be operated differently to such an extent that such a compensation current may flow, wherein, however, at the same time an input voltage or output voltage may still be controlled in accordance with the respective requirements. It has thus been recognized that there is still at least one degree of freedom that may be used and accordingly allows different control of the two inverter devices.

Provision may in particular be made for the inverter devices to have different absolute voltage potentials in their DC voltage intermediate circuit, that is to say there are different voltage levels with respect to a common reference potential, for example earth potential. These may be achieved through appropriate differing control of the inverter devices. In this case, however, the intermediate circuit voltage of both inverter devices may each be the same, although it does not have to be the same.

To give a simple illustrative example, both intermediate circuit voltages could have a value of 800 volts (V). In this case, in one inverter device, this intermediate circuit voltage could consist of +400 V and −400 V, each with respect to earth potential, whereas, in the other inverter device, it could consist of +450 V and −350 V with respect to earth potential. In spite of the same intermediate circuit voltage of 800 V, there would be a potential difference of 50 V between the two inverter devices in this mentioned illustrative example, which could be used to generate the compensation current.

In this case too, provision is made for this potential difference to be able to be set in terms of level and also to have to be set only temporarily. In this case too, the level of excess power that is thereby output may be controlled through duration and amplitude. In the example mentioned, it could be sufficient to provide a respective load resistor between the two positive intermediate circuit voltage points and the two negative intermediate circuit voltage points. If no compensation current is intended to flow, both inverter devices are operated such that there is no potential difference between the two intermediate circuit voltages. No compensation current will then flow, and no excess power will be output, without the need for a switch for disconnecting the load resistors.

It is therefore proposed, according to one embodiment, for provision to be made for multiple inverter devices connected in parallel with one another and each having one of the DC voltage intermediate circuits. The DC voltage circuits are connected via the at least one load resistor. The load resistor is thus interconnected between the two inverter devices. It is proposed in this case for at least one of the inverter devices to be raised and/or lowered to a general voltage potential with respect to a reference potential, that is to say for example with respect to earth potential, such that a compensation current is established through the at least one load resistor.

This reference potential may be raised for example such that the inverter device is operated at its voltage input in the sense of an active rectifier, which is able to be controlled such that the DC current is accordingly channeled into the positive and negative portion of the DC voltage intermediate circuit such that a corresponding potential is established. In other words, more DC current is thus channeled into the positive portion when the voltage potential is intended to be raised.

According to one variant, it is proposed in this case for the voltage potential of the DC voltage intermediate circuits to be set with respect to a reference potential, in particular with respect to earth potential, such that they have a voltage difference in relation to one another that leads to a compensation current through the at least one load resistor. This thus also corresponds to the case already explained in detail above.

In addition or as an alternative, provision may be made for the inverter device to have a respective voltage input in the form of an AC voltage input and for a voltage signal to be modulated on at least one of the AC voltage inputs, such that a mean voltage shift is established with respect to the reference potential, resulting in a compensation current that flows, inter alia, through the load resistor. The compensation current and thus the excess power are thus controlled via this modulated voltage signal. The compensation current may also flow between the inverter devices in the region of the voltage input, but it may also flow through the at least one load resistor, which is preferably interconnected between the two DC voltage intermediate circuits.

According to one additional or alternative embodiment, it is proposed for the inverter devices to each have a voltage output in the form of an AC voltage output and for a voltage signal to be modulated on at least one of the AC voltage outputs, such that a mean voltage shift is established with respect to the reference potential, resulting in a compensation current that flows, inter alia, through the load resistor. Provision may thus be made here for modulation on the voltage output. It is in particular proposed here for the inverter device to have its respective DC voltage intermediate circuit as voltage input It has thus in particular been recognized here that provision may also be made for an inverter device that does not convert from AC current to AC current, but rather from DC current to AC current or vice versa. In this case too, said modulation in the AC voltage range, specifically a voltage output here, may be used to generate the potential difference that leads to the compensation current.

In particular, in said cases, the intermediate circuit voltage or the voltage potential in the DC voltage intermediate circuit may be considered to be a system voltage that is changed.

According to one embodiment, it is proposed for provision to be made for multiple inverter devices connected in parallel with one another, each having a voltage input in the form of an AC voltage input, wherein the AC voltage inputs are connected via the at least one load resistor, and a voltage signal is modulated on at least one of the AC voltage inputs, such that a mean voltage shift is established with respect to the reference potential, resulting in a compensation current that flows through the at least one load resistor.

Provision is therefore in particular made here for the load resistor not to be interconnected between the DC voltage intermediate circuits, but rather on the AC voltage side between the two AC voltage inputs of the two parallel-connected inverters. This may also be provided analogously on the output side of the inverter devices. The AC voltage signals are basically identical here. Provision is made in particular for respective three-phase AC voltage signals or AC current signals that each have the same frequency, phase and amplitude between the two inverter devices, but with the difference that their reference potential is raised from one inverter device to the other, that is to say, in other words, they have a DC offset.

Such a DC offset in particular does not influence the respective operation of the individual inverter devices, at least not significantly. An effect is established only in the comparison between the two inverter devices that have different DC offsets or one of which has no DC offset, and this effect may be used to allow a compensation current to flow through the at least one load resistor. A three-phase system is preferably assumed, and provision is accordingly made for three load resistors, specifically one for each phase.

However, provision may also be made for such modulation of an offset on one of the AC sides, wherein, however, at least one load resistor is provided between the DC voltage intermediate circuits for the compensation current. This is based in particular on the finding that a current basically flows in a circle. A modulated signal on the AC voltage input or output may thus lead there to a compensation current, which may however at the same time also flow back in the region of the DC voltage intermediate circuits in the event of appropriate interconnection with load resistors or one load resistor. In this case, provision may thus also be made for the excess power to be output by at least one load resistor that is interconnected between the DC voltage intermediate circuits.

It is preferably proposed for the inverter devices to be interconnected with one another at their DC voltage intermediate circuits such that the compensation current or a portion thereof flows back in the region of the DC voltage intermediate circuits. The effect has been explained above.

In addition or as an alternative, it is proposed for the inverter devices to be interconnected with one another at their voltage outputs such that the compensation current or a portion thereof flows back in the region of the voltage outputs. In this case, this is in particular understood to mean AC voltage outputs, and the at least one load resistor may be arranged there.

According to one embodiment, it is proposed for the at least one inverter device to be interconnected with a generator and/or consumer having a star point To this end, it is proposed for the at least one load resistor to be interconnected between the star point and a connection point of the DC voltage intermediate circuit and for a voltage potential to be changed such that a compensation current is established through the load resistor, the star point and the generator or consumer.

Provision is thus made here for a topology in which a load or a source has a star point whose potential may initially be assumed to be 0, to put it clearly. To this end, provision may likewise be made, in the DC voltage intermediate circuit, for a voltage center tap that basically has the same potential as the star point. Provision is in particular often made for a DC voltage intermediate circuit that has two series-connected and identically sized capacitors. Provision may be made for an interconnection to the star point between these intermediate circuit capacitors, as they are known. Normally, basically no current then flows through this connection line to the star point However, in order to generate a compensation current for outputting excess power, the voltage potential of the DC voltage intermediate circuit may be changed such that a potential difference may then arise at the star point, this being able to be used to modulate the compensation current.

This also serves for illustrative purposes, and it is not absolutely necessary for provision actually to be made for two series-connected intermediate circuit capacitors in the DC voltage intermediate circuit between which a tap is routed to the star point of the load or the source. By way of example, a single capacitor may also be connected to a connection of the DC voltage intermediate circuit, and the connection to the star point may be created through it and, when a signal is modulated onto this star point, a corresponding compensation current may flow through it, in order thereby to output the excess power.

To this end, provision is preferably made for a voltage signal to be modulated on a respective voltage input designed in the form of an AC voltage input, such that a mean voltage shift is established with respect to the reference potential, resulting in a compensation current that flows through the at least one load resistor. It has in particular also been recognized here that the compensation current is basically also able to flow at least partially outside the inverter device, in particular may also involve the consumer or generator, that is to say the load or source. Modulation may therefore take place such that this also affects the load or source, and the compensation current may then in this respect flow partially through this load or source if the load resistor via which the excess power is to be dissipated is interconnected appropriately. To this end, an interconnection via the star point of the load or source is proposed.

According to a further embodiment, it is proposed for the at least two inverter devices to be connected in parallel with one another and each to be interconnected with a generator and/or consumer having a star point To this end, it is proposed for the at least one load resistor to be interconnected between the star points. A voltage potential is then changed such that a compensation current is established through the load resistor, the star point and the generator or consumer.

It is in particular proposed, for this purpose, for a voltage signal to be modulated on at least one of the voltage inputs designed in the form of AC voltage inputs, such that a mean voltage shift is established with respect to the reference potential, resulting in a compensation current that flows through the at least one load resistor between the star points. The voltage at the voltage inputs is thus changed such that this voltage at the voltage inputs constitutes the system voltage that is changed. This is also correspondingly possible in an analogous manner at the voltage outputs, or the voltage inputs may also be controlled by appropriately controlling the inverter device so as to output power. In this case too, the load or source is thus involved, wherein a second inverter device, and thus its second load or second source, is also involved.

According to one embodiment, it is proposed for provision to be made for at least two inverter devices, which each have their DC voltage intermediate circuit as voltage input and are interconnected in parallel with one another, wherein their DC voltage intermediate circuits are interconnected in parallel. To this end, provision is made for their voltage outputs to be connected via at least one load resistor. This embodiment thus basically relates to an inverter that generates an AC current from a DC voltage and in this case does not have any unit that previously generated the DC voltage from an AC current.

To this end, provision is made for a voltage signal to be modulated on at least one of the voltage inputs designed in the form of AC voltage outputs, such that a mean voltage shift is established with respect to the reference potential, resulting in a compensation current that flows through the at least one load resistor between the AC voltage outputs, and the two inverter devices thus have a connected or even common DC voltage intermediate circuit, and provision is made for balancing resistors at the AC voltage output, which may in principle also function as an input, specifically particularly preferably one balancing resistor per phase. The compensation current that is brought about by the modulated voltage signal, specifically by the potential difference that arises between the two AC voltage outputs of the two inverter devices, may then flow through these load resistors. The output voltage at the AC voltage output should be understood here to mean the system voltage that is changed in order to generate the compensation current.

According to one embodiment, it is proposed, in the case of multiple inverter devices connected in parallel with one another, if these inverter devices each have an AC voltage output as voltage output and a respective output voltage is generated or influenced by a signal pulsed by switches at the AC voltage output, for a differential potential to be generated between the AC voltage outputs by virtue of the switches of the respective inverter outputs each being controlled with different switching times, switching times that are offset at least in relation to one another, wherein the differential potential leads to a compensation current through a load resistor.

It is thus proposed for these inverter devices to differ in terms of their pulse modulation at their AC voltage outputs. The pulse modulation basically takes place for the inverter devices so as to give the desired AC current, but it has been recognized that there is additionally a degree of freedom that enables the voltage potential to be influenced at the same time. The different modulation then results in the differential potential, which may be set accordingly in order to control the compensation current. In this case too, it is of course the case that these output voltages may also accordingly be modulated in the same way in order to avoid a potential difference, in order not to obtain a differential potential, such that there is no compensation current if this is not desired. The compensation current may accordingly also be controlled depending on the pulse modulation.

The adjustment of the system voltage, in particular the adjustment of the input voltage, output voltage and the intermediate circuit voltage, is preferably varied over time with respect to the voltage level and/or the division between the inverter devices. This is proposed in particular so that the inverter device is loaded essentially evenly by the compensation currents on average over time. To put it simply, the respective modulations may alternate in order to make the loading uniform.

In addition or as an alternative, it is proposed, when the system voltage of only one or a few inverter devices changes according to a predetermined criterion, for the change in the system voltage to change over to at least one further inverter device, such that the system voltage is changed on average, but not at the same time, on all inverter devices. In particular, as predetermined criterion, provision is made for a predetermined time, which may for example be referred to as changeover time. If the changeover time expires, the change in the system voltage changes over to at least one further inverter device, as long as excess power is intended to be output anyway.

To this end and also for all of the other embodiments explained above, it should be mentioned that it may be considered to use not only two inverter devices, but also more than two inverter devices. If these do not interact, they may each be controlled or provided individually, as proposed. Insofar as they interact, that is to say in accordance with the other embodiments, that is to say in particular are connected in parallel, more than two may also be connected in parallel. Load resistors may then also be interconnected accordingly, for example between each of the more than two inverter devices. In the case of three or more inverter devices, however, at least one load resistor does not have to, but may, be interconnected between each inverter device, but rather for example only between two adjacent ones. In the case of an even number of multiple inverter devices used, an interconnection in pairs may basically also be considered.

In particular in the case of three or even more inverter devices, it is proposed for the modulation loading and/or the direct loading caused by the compensation current, as far as possible, to be gradually forwarded to a further inverter device in order to achieve balanced loading.

According to one embodiment, it is proposed, in the event that at least two inverter devices are connected in parallel with one another, for at least one additional consumer to be supplied by a DC voltage intermediate circuit to be interconnected between the multiple DC voltage intermediate circuits of the inverter devices via a rectifying device, such that the additional consumer is in each case effectively connected between a highest and/or lowest voltage potential of the DC voltage intermediate circuits.

It has in particular been recognized here that the intended change in the system voltage, in order thereby to generate a compensation current, in order thereby to generate a compensation current, also creates a special topology. Basically, of course, it is undesirable to consume power that is not used. If it is not possible to achieve meaningful use, such giving away of power is acceptable if it serves system safety and/or system stability purposes, in particular grid stability purposes for an electricity supply grid into which infeeding is performed by way of the at least one inverter device. However, if there is meaningful consumption that is able to be fully or partially operated with such sporadically occurring excess power, or is at least additionally able to utilize it, then this may be connected and controlled in the described manner. Specifically, it is connected in particular between a high and low potential of two DC voltage intermediate circuits of two inverter devices and may then be controlled in connection with the changing of the system voltage.

According to one embodiment, it is proposed for the load resistor to be designed as a resistor with a non-linear current-voltage characteristic curve. It has in particular been recognized here that, by changing the system voltage, a current is set on the basis of the load resistor, which current depends specifically on the current-voltage characteristic curve of the load resistor. A characteristic curve in which the current increases disproportionately with increasing voltage in particular opens up the possibility of achieving very high compensation currents by changing the system voltage. Such a non-linear current-voltage characteristic curve may be achieved in particular using a varistor.

An inverter arrangement is also proposed. Such an inverter arrangement has at least one inverter device for generating at least one AC voltage, and the at least one inverter device or each of the inverter devices each comprises at least one voltage input for applying an input voltage, at least one voltage output for outputting an output voltage, at least one DC voltage intermediate circuit for providing an intermediate circuit voltage and a control device for controlling the inverter device. The inverter arrangement also has a load resistor for consuming a compensation current. In this case, the control device is prepared to control an AC voltage at the voltage output of the relevant inverter device so as to output a first portion of an input power in the form of useful power, or to receive the input power or a portion thereof. Each control device is also prepared to change a system voltage of the inverter device such that at least one compensation current flows through at least one load resistor, in order thereby to output a second portion of the input power or the entire input power to the at least one load resistor in the form of excess power.

The inverter arrangement is in particular designed in the manner as emerges from the description of at least one embodiment of the described method. In addition or as an alternative, the inverter arrangement is prepared to be operated in accordance with at least one method described above. The advantages of such an inverter arrangement accordingly result from the explanations described above of the embodiments of the described methods. The inverter arrangement in particular comprises at least two inverter devices, each having a control device, and the inverter arrangement comprises a central controller for coordinating the control units and thus for coordinating the inverter devices. In particular for the embodiments that propose or are based on multiple parallel-connected inverter devices, the behavior of the inverter devices with respect to one another is important, and the central controller is provided for this purpose.

A method in accordance with at least one embodiment described above is in particular implemented on each control device and/or the central controller.

The load resistor is preferably designed as a resistor with a non-linear current-voltage characteristic curve.

A wind power installation having at least one inverter arrangement is also proposed.

The inverter arrangement that is proposed is one in accordance with at least one embodiment described above. The wind power installation is prepared to feed electric power into an electricity supply grid by way of the inverter arrangement and, if necessary, to output power in at least one load resistor through at least one compensation current in the form of excess power. This is achieved in particular by changing at least one system voltage of at least one of the inverter devices.

The wind power installation is thus intended to feed into and also support the electricity supply grid. In particular when the electricity supply grid suddenly needs to reduce power to be fed in abruptly, or even to draw power from the electricity supply grid by way of the wind power installation, this may be output into the at least one load resistor through the compensation current in the form of excess power. The wind power installation may thereby perform such grid support easily and quickly, this being possible with a comparatively low component outlay. In particular, a chopper circuit does not need to be kept available.

### BRIEF DESCRIPTION OF THE SEVERAL VIEWS OF THE DRAWINGS

The invention is now explained by way of example in more detail below on the basis of embodiments with reference to the accompanying figures.

FIG. 1 shows a schematic perspective illustration of a wind power installation.

FIG. 2 schematically shows an inverter arrangement having multiple inverter devices and a central controller.

FIGS. 3A-3W show schematic circuit diagrams of various embodiments of an inverter arrangement.

### DETAILED DESCRIPTION

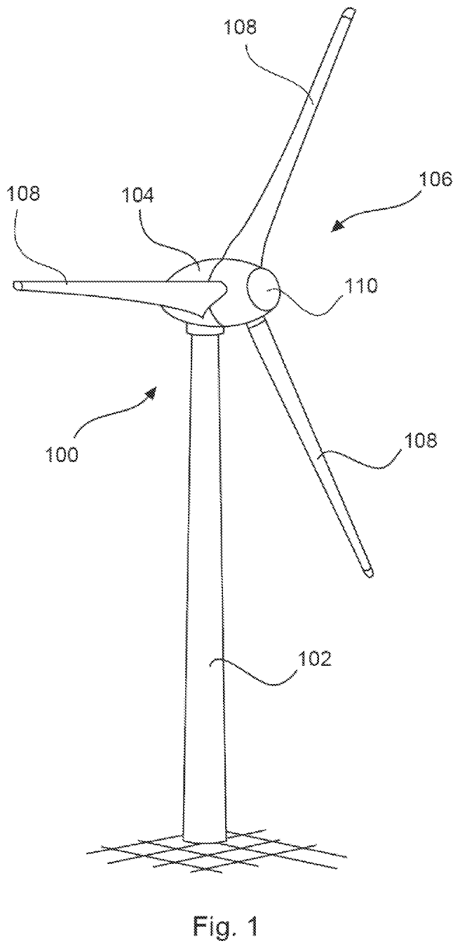

FIG. 1 shows a wind power installation 100 having a tower 102 and a nacelle 104. A rotor 106 having three rotor blades 108 and having a spinner 110 is arranged on the nacelle 104. During operation, the rotor 106 is set in rotation by the wind and thereby drives a generator in the nacelle 104.

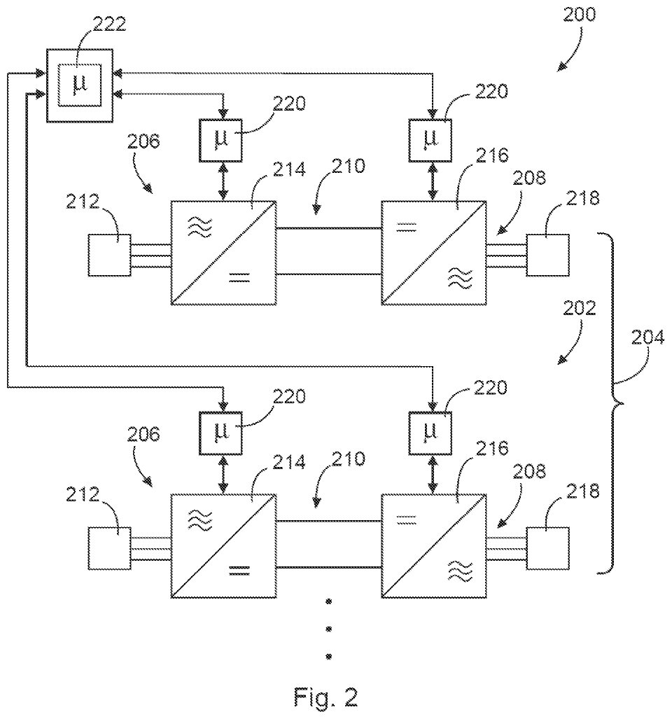

FIG. 2 schematically shows an inverter arrangement 200 having, by way of example, two inverter devices 202. These two inverter devices 202, and there may also be more than two, or there may in principle also be only one, are linked to one another, this being intended to be indicated by the symbolically illustrated linking brackets 204. Details of the links are not shown in FIG. 2, in particular because different links may be considered. Provision is made in particular for a link via at least one load resistor. However, it may also be considered for each inverter device 202 to have its own load resistor for outputting excess power, and for the linking of the inverter devices 202, for example, to provide for the inverter devices 202 to be coordinated only to the extent that coordination takes place as to when which inverter device implements excess power via the respective load resistor and, if applicable, to what level.

The following figures then explain details about possible embodiments of both individual inverter devices 202 and multiple combined inverter devices 202.

The inverter devices 202 in FIG. 2 each have a voltage input 206, a voltage output 208 and a DC voltage intermediate circuit 210. An input voltage may in each case be received here from an input source 212 and rectified in an input-side rectifier 214 and applied to the respective DC voltage intermediate circuit 210. From there, an inverter 216 may invert the DC voltage and output it to an output load 218 at the voltage output 208 in the form of AC voltage. To this extent, the two inverter devices 202 that are shown, including their wiring through input source and output load 218, are illustrated as being identical for the sake of simplicity. However, this may also vary in principle.

In addition, the active flow direction illustrated above from the input source 212 to the output load 218 may for example also be reversed. This applies both to the basic structure, but in particular also to the type of control, which may in principle reverse this active flow and may in particular control it essentially as desired. It is in particular proposed for the input-side rectifier 214 also to be able to be operated as an inverter and to be designed accordingly, and/or for the inverter 218 to be able to be operated as a rectifier and to be designed accordingly. In this respect, each input source may also be an input load and consume a voltage or corresponding power. Analogously, each output load 218 may also be an output source and input a corresponding voltage at the voltage output 208 or input a corresponding power there. Such variations are possible in principle through appropriate control.

Each inverter device has two control devices (e.g., controllers) 220. Here, by way of example, two control devices 220 are provided in each case for each inverter device 202, specifically one for the input rectifier 214 and one for the inverter 216. As an alternative, however, the two control devices 220 of each inverter device 202 may also be combined to form one control device. The control devices 220, which are illustrated as being identical here for the sake of simplicity, may in principle differ between the input rectifier 214 and the inverter 216. In principle, however, as indicated above, the inverter 216 may be operated as a rectifier 214 and the rectifier 214 may also be operated as an inverter 216.

Finally, provision is made for a central controller 222 for controlling and/or coordinating the inverters 202 of the inverter arrangement 200. This central controller 222 controls and/or coordinates the inverter devices 202, in particular via the control devices 220 that are provided in each case. Each double-headed arrow in this case indicates that information is able to be transmitted in any direction.

Both the input rectifier 214 and the inverter 216 may in this respect also each be referred to as partial converters, and the input rectifier 214 may thus be referred to synonymously as first partial converter (partial converter 1) and the inverter 216 may be referred to synonymously as second partial converter (partial converter 2).

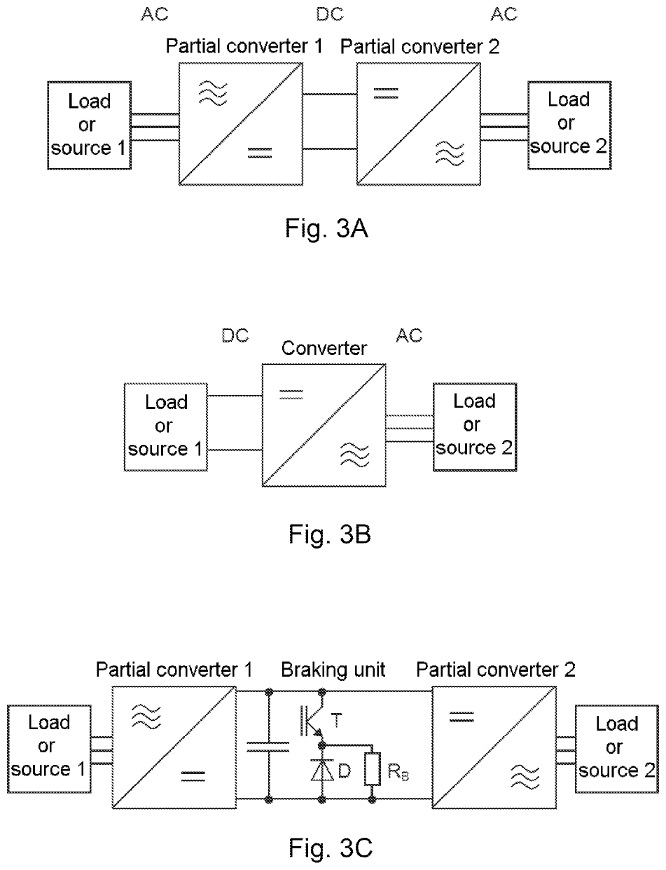

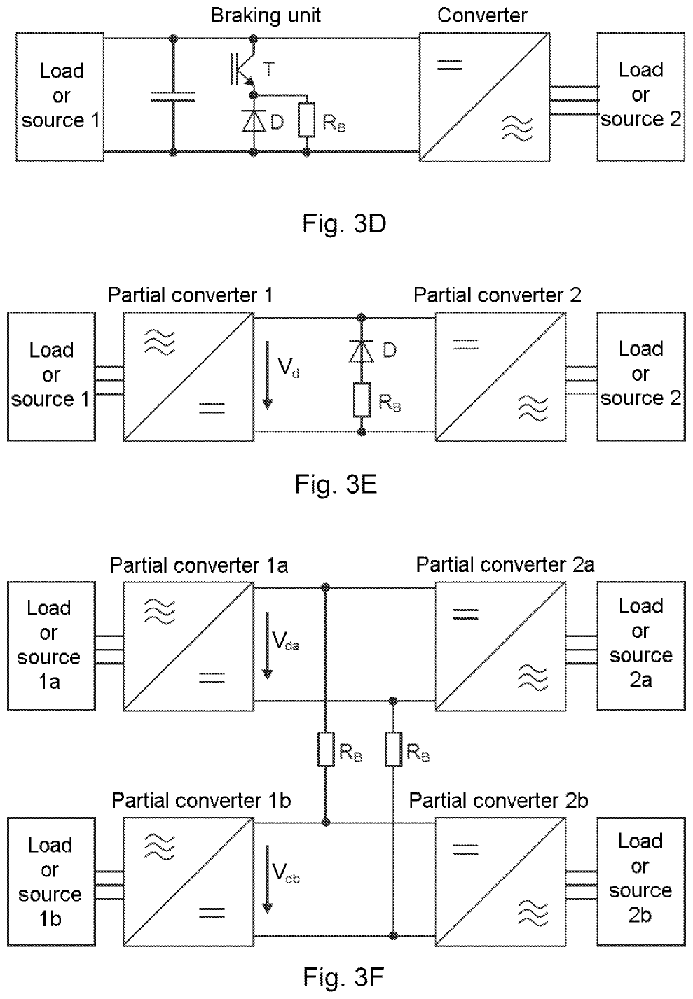

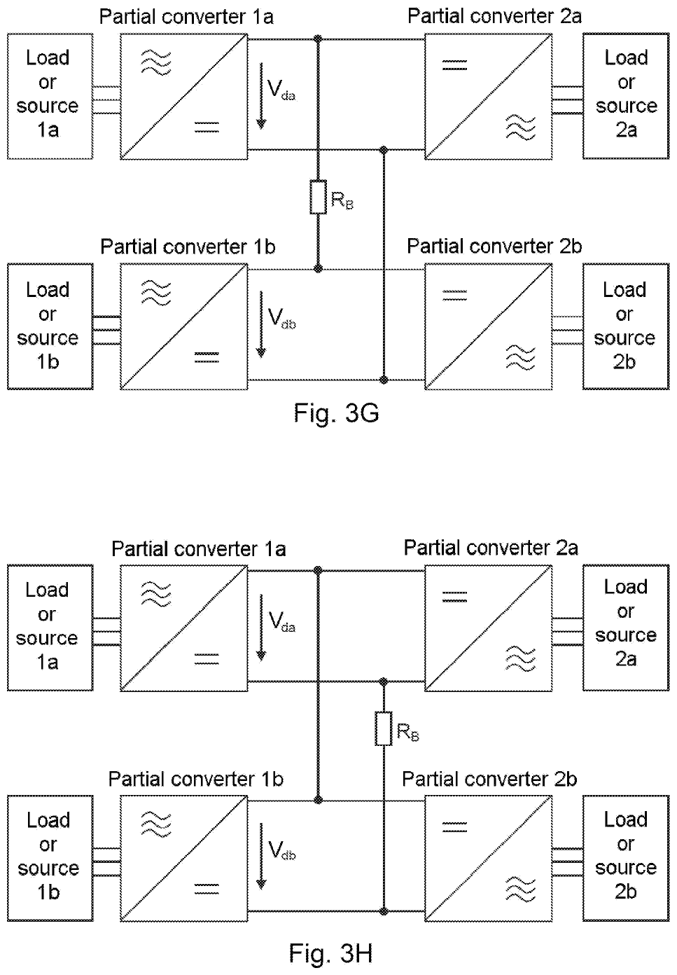

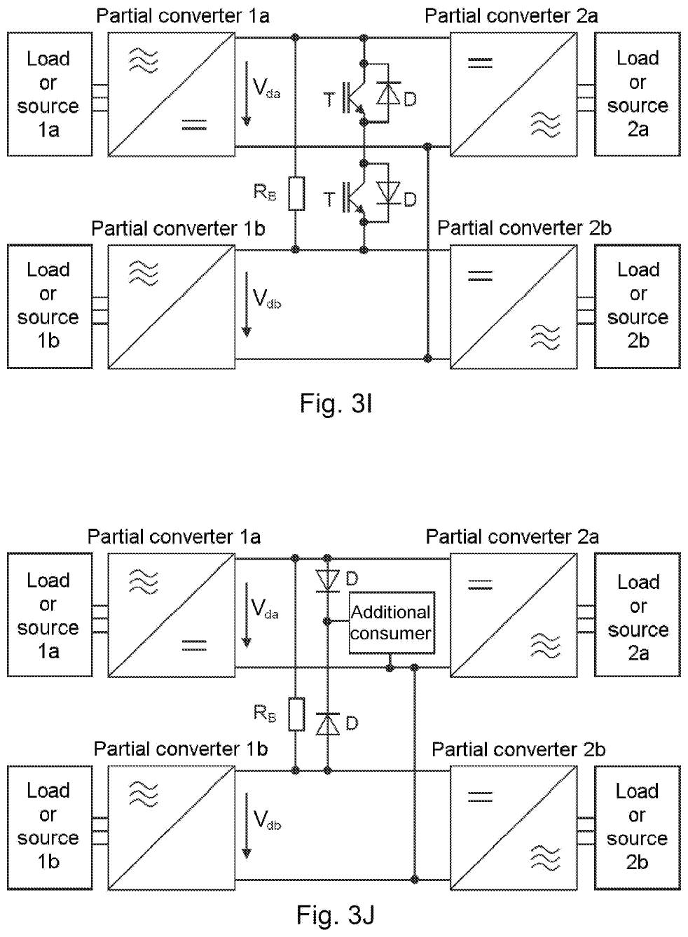

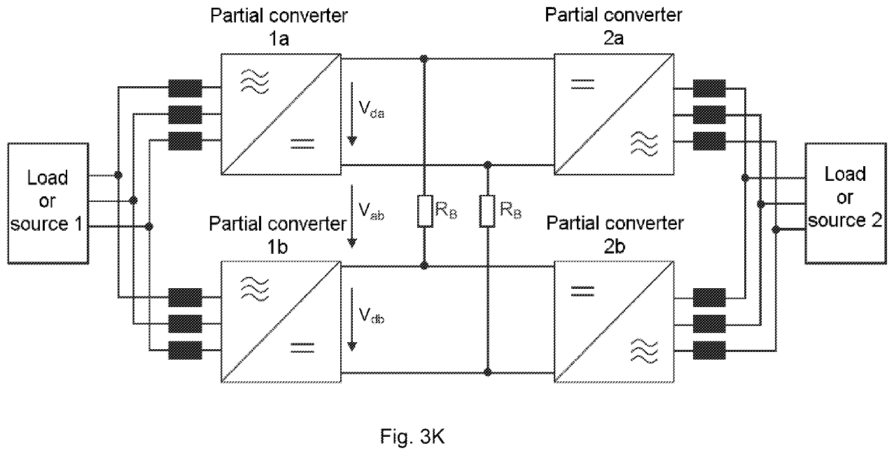

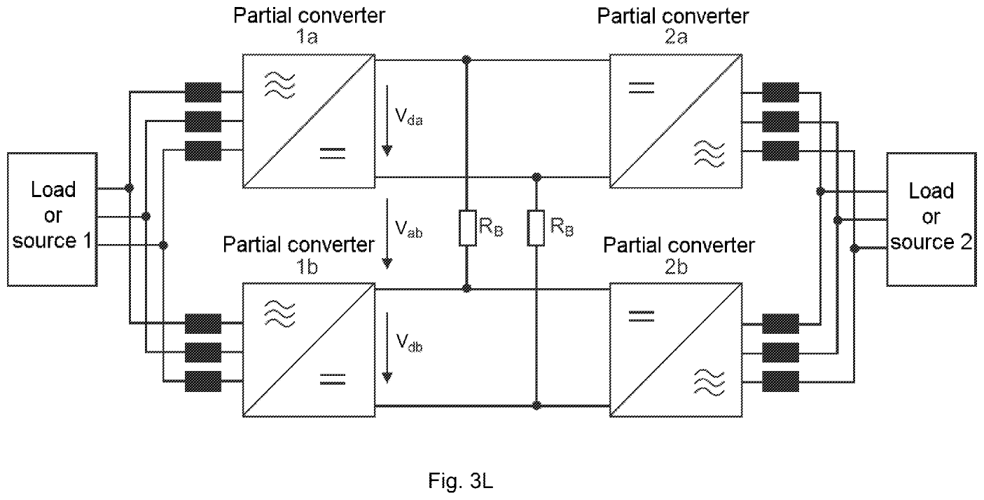

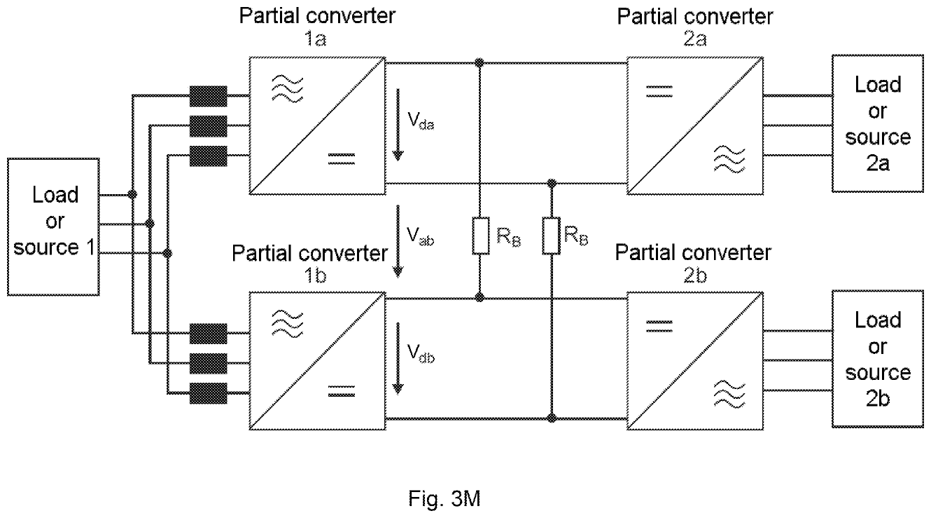

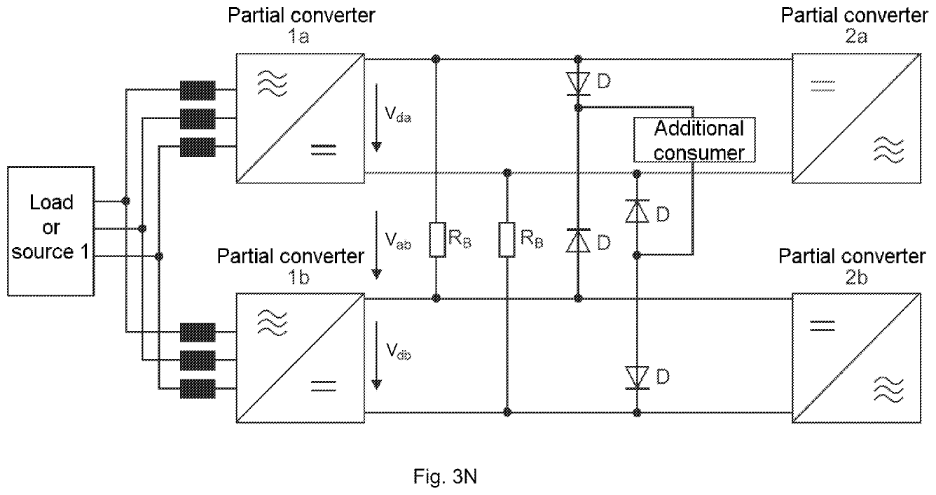

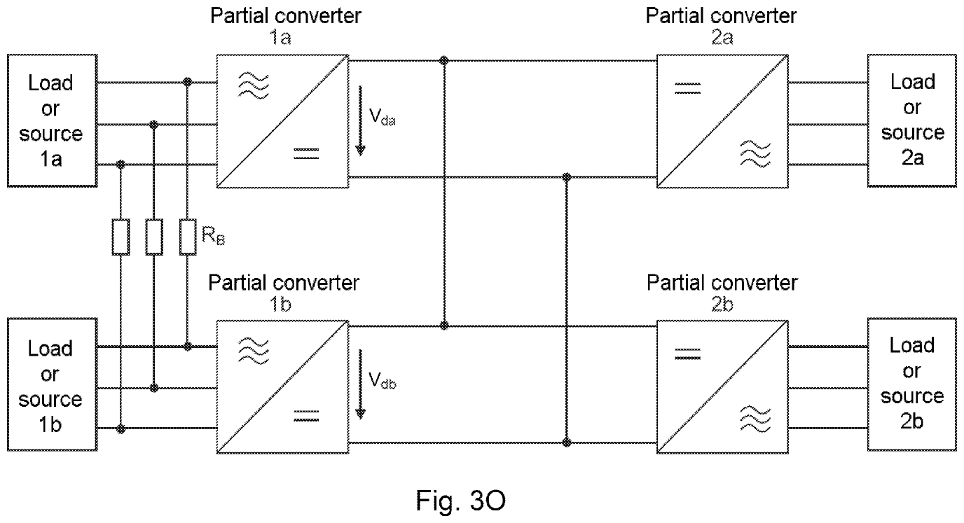

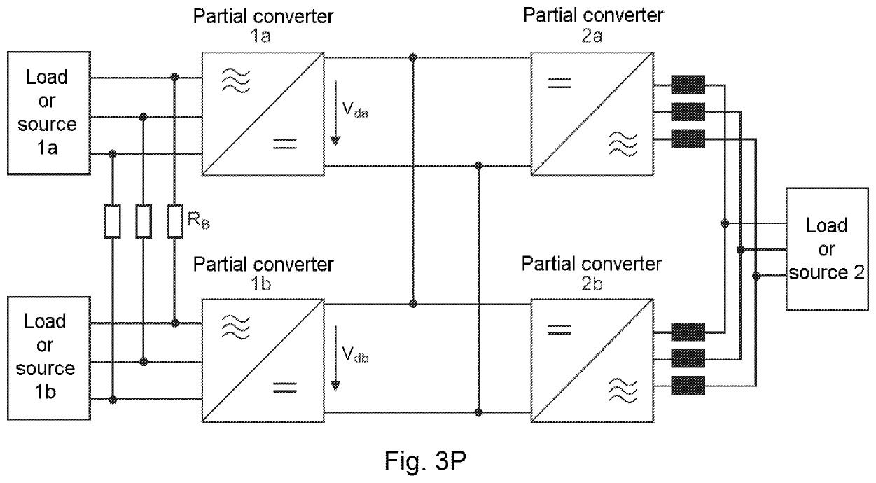

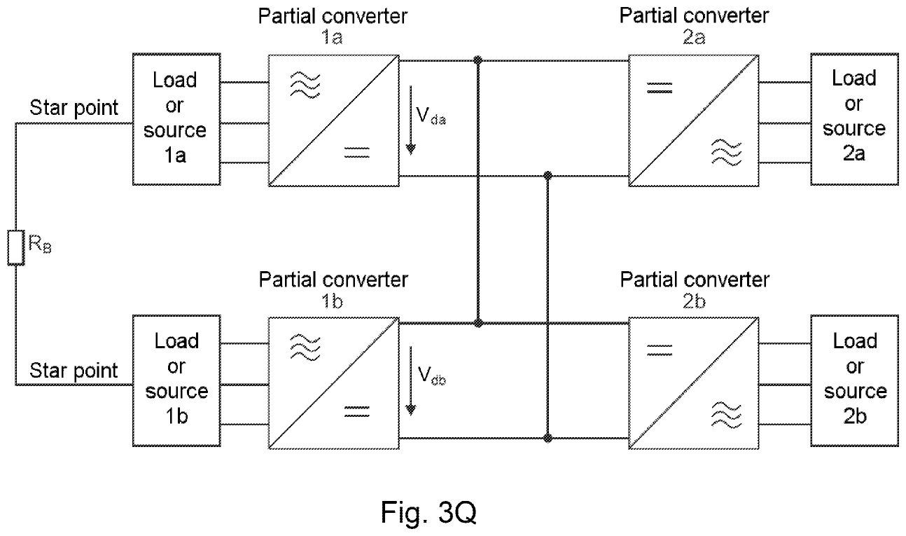

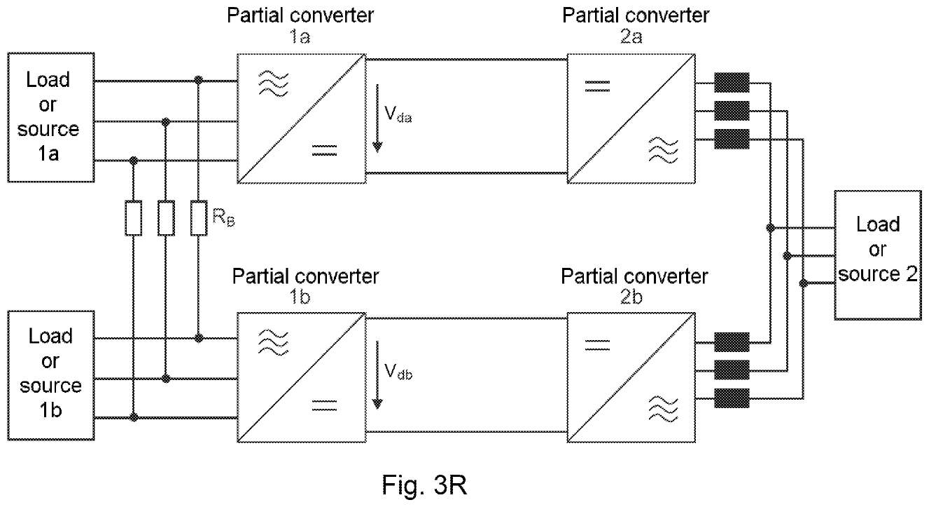

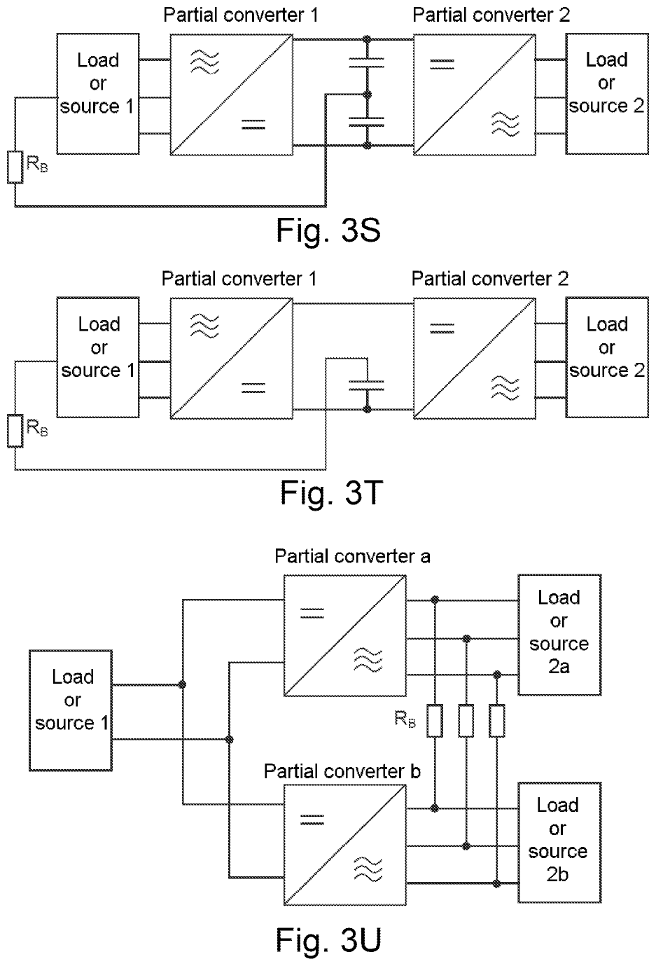

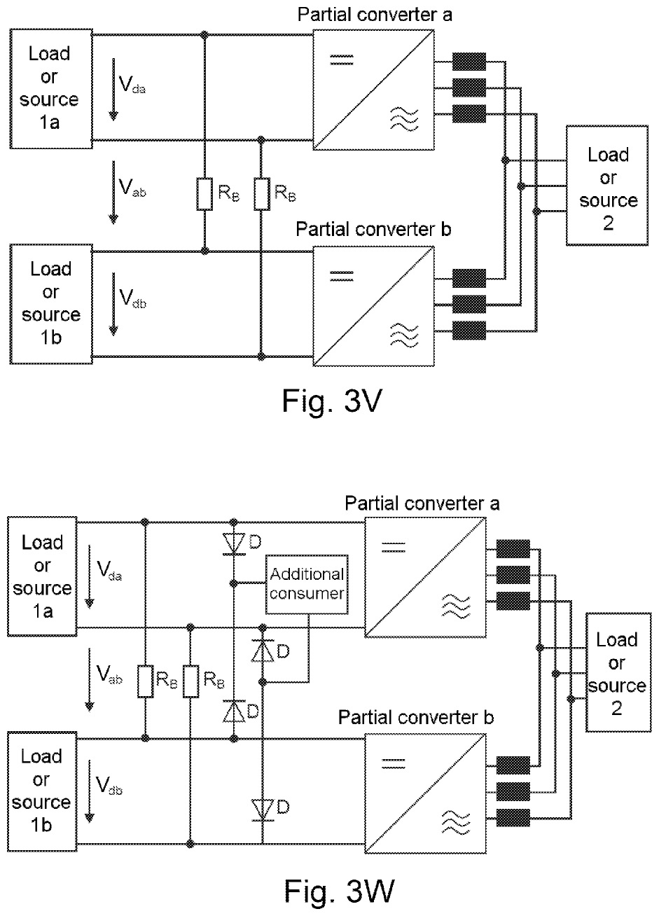

Provided herein are power electronics converters that connect an AC power source (source) to an AC power sink (load) and for this purpose—as is the state of the art today —perform a two-stage conversion from AC (AC or three-phase voltage) to AC (AC or three-phase voltage) via a DC intermediate circuit (DC voltage). The underlying structure is shown schematically in FIG. 3A.

Some embodiments also relate to converters that connect a DC source (or load) to an AC load (or source), as shown schematically in FIG. 3B.

If the source feeds more power into this converter than the load draws, a power excess arises.

According to the prior art, this power excess is converted into heat in a resistor using a braking unit. In terms of circuitry, the braking unit, which may also be referred to as a chopper circuit, is a step-down converter. It comprises a deactivatable power semiconductor (for example an IGBT, MOSFET or IGCT), a freewheeling diode, the intermediate circuit capacitor (possibly present in the converter in any case) and the braking resistor itself.

To this end, FIG. 3C shows a braking unit (e.g., chopper or step-down converter) for an AC/AC converter and thus for a structure according to FIG. 3A and FIG. 3D for a DC/AC converter and thus for a structure according to FIG. 3B.

Provided herein is reducing the circuitry outlay for the brake divider or saving on it entirely, and being able to control the braking resistor without additional power semiconductors. Various embodiments are explained by way of example below in this regard.

One variant may be referred to as an AC/AC converter with DC voltage of reversible polarity.

It is assumed in this case that the partial converters make it possible to reverse the polarity of the voltage of the DC intermediate circuit. This is the case for example with current intermediate circuit converters and with some modular multilevel converters, and is known to those skilled in the art.

In this embodiment, the braking resistor is arranged in series with a diode in the intermediate circuit. The braking power is controlled by the level of the negative intermediate circuit voltage Va. This is shown in FIG. 3E.

The circuit comprises the series connection of braking resistor RB and diodes D between the two poles of the intermediate circuit voltage. To this end, it is proposed to control the braking unit by reversing the polarity of the intermediate circuit voltage V_{d} and changing the absolute value of the intermediate circuit voltage.

One embodiment uses an AC/AC converter, with two partial converters and braking unit control through different DC voltages. The term converter is used synonymously here and below for an inverter arrangement, in particular for an inverter arrangement 200 in the sense of FIG. 2. The term partial converter is used generally here and below and may denote both an inverter device like or similar to the inverter device 202 according to FIG. 2, and also parts thereof, and also a rectifier, in particular a rectifier 214 according to FIG. 2, and/or also an inverter, in particular an inverter 216 according to FIG. 2.

It is now assumed that the converter has at least two partial converters a and b, each of which has a DC voltage intermediate circuit similar to the DC voltage intermediate circuit 210 according to FIG. 2 (or more than two partial converters; the explanations then apply accordingly). The partial converters have a controllable DC intermediate circuit voltage Va. It is not necessary in this case for the polarity of the intermediate circuit voltage to be able to be reversed. The intermediate circuits of both converters, that is to say both inverter devices here, are connected via braking resistors.

During normal operation, both converters have the same intermediate circuit voltage Va., and so no current flows. During braking operation, different intermediate circuit voltages are established, such that there is a flow of power from the converter with a higher intermediate circuit voltage to the one with a lower intermediate circuit voltage through the braking resistors. A portion of the power is thereby converted into heat in the braking resistors. If an AC voltage phase-shifted by 180° is superimposed on both DC intermediate circuit voltages, then the flow of power from one to the other intermediate circuit balances out over a period of this AC voltage, and the power consumption in the braking resistor remains. The structure for this is shown in FIG. 3F, which makes provision to control the braking unit by superimposing a phase-shifted AC voltage on the DC intermediate circuit voltages.

In this case, provision is made to connect the intermediate circuits via braking resistors in connection with superimposition of a phase-shifted AC voltage onto the DC voltage V_{da} and V_{db}.

Instead of two resistors, only one resistor and a low-resistance connection of the intermediate circuits may also be implemented. FIG. 3G and FIG. 3H show two variants in this regard.

Instead of a resistor with a largely linear I=f(V) characteristic, it is also possible to use a varistor or other element with a strongly non-linear characteristic, that is to say a resistor with a non-linear current-voltage characteristic curve. In particular, such a characteristic curve is proposed in which no current flows even if there are small differences in the intermediate circuit voltages, but the difference between the intermediate circuit voltages does not have to become too large for a high current flow and thus high power. In this case, the characteristic is thus such that the current increases disproportionately with the voltage, that is to say in each case with respect to the absolute values. This also applies to all other and above embodiments.

If, for overriding reasons, it is advantageous to connect the partial intermediate circuits a and b during normal operation, this may be achieved using deactivatable low-voltage power semiconductors, in particular using transistors. This is particularly advantageous when only a very low current flows between the intermediate circuits during normal operation. Such transistors T are deactivated during braking operation. This variant is shown in FIG. 3I.

If another consumer is intended to be supplied from the two partial intermediate circuits, this may be achieved using decoupling diodes. During normal operation, this consumer is supplied from both partial intermediate circuits, and thereby from the higher-voltage partial intermediate circuit during braking operation. This is shown in FIG. 3J.

Another embodiment in which different intermediate circuit voltages are generated during braking operation is that of the AC-side coupling of the converters (for one or both sources or loads). This is shown in FIG. 3K.

Another embodiment relates to an AC/AC converter consisting of two partial converters, coupled on the AC side with braking resistors between the DC intermediate circuits, and braking unit control through circulating currents.

It is again assumed in this case that the converter consists of at least two partial converters a and b (or even more than two partial converters; the explanations then apply accordingly). At least one AC output of the converter is connected. Modulating a (different) offset (common-mode voltage) onto the output voltages of the two partial converters 1a and 1b or 2a and 2b results in a voltage V_{ab} other than zero between the intermediate circuits. Since the intermediate circuits of both converters are in turn connected via braking resistors, a circulating current flows through the braking resistors.

This is shown in FIG. 3L, which makes provision for the braking unit to be controlled through different offset voltages on the converter output voltages in the case of converters coupled on the AC side with braking resistors between the DC intermediate circuits. The structure basically corresponds to that of FIG. 3K, but, in FIG. 3L, different offset voltages are generated at the AC inputs or outputs, whereas, in FIG. 3K, provision was made to generate, in particular directly generate, different intermediate circuit voltages. According to one embodiment, these variants may also be combined.

For this purpose, it is thus generally proposed to connect the intermediate circuits to braking resistors in connection with different offset voltages for the partial converters coupled on the AC side.

To this end, one embodiment makes provision for coupling only on an AC side, which is shown in FIG. 3M.

An embodiment with varistors instead of linear resistors may also be implemented here and is proposed, as is an embodiment for supplying additional consumers.

Such an embodiment with the possibility of supplying further consumers from both intermediate circuits is shown in FIG. 3N.

Another embodiment relates to an AC/AC converter consisting of two partial converters, coupled on the DC side with braking resistors between the AC outputs, and braking unit control through circulating currents.

It is again assumed in this case that the converter consists of at least two partial converters a and b (or even more than two partial converters; the explanations then apply accordingly). The DC intermediate circuits are connected. Modulating a (different) offset (common-mode voltage) onto the output voltages of the two partial converters 1a and 1b or 2a and 2b results in a voltage other than zero between the AC outputs. Since the AC outputs of both converters are connected via braking resistors, a circulating current flows through the braking resistors.

For this purpose, it is generally proposed to connect the AC outputs of the converters to braking resistors in connection with different offset voltages for the partial converters coupled on the DC side.

FIG. 3O illustrates a corresponding structure with the braking unit being controlled by different offset voltages on the converter output voltages in the case of converters coupled on the DC side with braking resistors between the AC outputs.

According to one embodiment, the resistors may also be arranged on both AC sides. Another embodiment with varistors instead of linear resistors may also be implemented here. The AC-side outputs at which no braking resistors are used may likewise be coupled.

FIG. 3P shows one embodiment with additional coupling on an AC side.

In yet another embodiment, the braking resistor is arranged between the star points of the loads (or sources).

FIG. 3Q shows such an embodiment with a braking resistor between the star points of the load.

Another embodiment relates to an AC/AC converter consisting of two partial converters, coupled on the AC side, with braking resistors between the AC outputs, and braking unit control through circulating currents.

It is again assumed here that the converter consists of at least two partial converters a and b (or even more than two partial converters; the explanations then apply accordingly). The AC outputs of a partial converter are connected. Modulating a (different) offset (common-mode voltage) onto the output voltages of the two partial converters 1a and 1b or 2a and 2b results in a voltage other than zero between the AC outputs of the other partial converter. Since the AC outputs of these two partial converters are in turn connected via braking resistors, a circulating current flows through the braking resistors.

It is thus proposed to connect the AC outputs of one partial converter to braking resistors in connection with different offset voltages for the partial converters coupled on the other AC side.

FIG. 3R shows such a structure with the braking unit being controlled by different offset voltages on the converter output voltages in the case of coupling on one AC side with braking resistors between the outputs on the other AC side.

An embodiment with varistors instead of linear resistors may also be implemented here.

Another embodiment relates to an AC/AC converter having a braking resistor at the star point of the load.

The braking resistor is in this case connected between the star point of the load and the center tap of the intermediate circuit A common-mode voltage on the AC output voltage causes a current through the braking resistor, but also a common-mode current through the load (or source).

FIG. 3S and FIG. 3T each show a variant of a structure with a braking resistor between the star point of the load and the center tap or other connection point of the intermediate circuit.

Another embodiment relates to a DC/AC converter consisting of two partial converters, coupled on the DC side, with braking resistors between the AC outputs, and braking unit control through circulating currents.

This embodiment considers a DC/AC converter. It is assumed that the converter consists of at least two partial converters a and b (or even more than two partial converters; the explanations then apply accordingly). The DC sides of the partial converters are connected. Modulating a (different) offset (common-mode voltage) onto the AC output voltages of the two partial converters a and b results in a voltage other than zero between the AC outputs. Since the AC outputs of both partial converters are connected via braking resistors, a circulating current flows through the braking resistors.

This embodiment thus proposes to connect the AC outputs of the converters to braking resistors in connection with different offset voltages for the partial converters coupled on the DC side.

An embodiment with varistors instead of linear resistors may also be implemented here.

FIG. 3U shows such a structure with the braking unit being controlled by different offset voltages on the converter output voltages in the case of converters coupled on the DC side with braking resistors between the AC outputs.

Another embodiment relates to a DC/AC converter consisting of two partial converters, coupled on the AC side, with braking resistors between the DC outputs, and braking unit control through circulating currents.

This embodiment again considers a DC/AC converter. It is assumed that the converter consists of at least two partial converters a and b (or even more than two partial converters; the explanations then apply accordingly). The AC outputs of the partial converters are connected. Modulating a (different) offset (common-mode voltage) onto the AC output voltages of the two partial converters a and b results in a voltage other than zero between the DC outputs. Since the DC outputs of both partial converters are connected via braking resistors, a circulating current flows through the braking resistors.

It is thus proposed to connect the DC outputs of the converters to braking resistors in connection with different offset voltages for the partial converters coupled on the AC side.

An embodiment with varistors instead of linear resistors may also be implemented here, as may an embodiment for supplying additional consumers.

FIG. 3V shows a structure with the braking unit being controlled by different offset voltages on the converter output voltages in the case of converters coupled on the AC side with braking resistors between the DC outputs.

FIG. 3W in this regard shows an embodiment with the possibility of supplying further consumers from both DC outputs.

1. A method for controlling alternating current (AC) voltage using an inverter device, the method comprising:
controlling the AC voltage at a voltage output of the inverter device to output a first portion of an input power as supply power or to receive the input power or a portion of the input power, wherein the inverter device includes the voltage input, a voltage output configured to output an output voltage and a direct current (DC) voltage intermediate circuit configured to provide an intermediate circuit voltage; and
changing a system voltage of the inverter device to cause at least one compensation current to flow through one or more load resistors and to output a second portion of the input power to the one or more load resistors as excess power.

2. The method as claimed in claim 1, comprising:
changing the input voltage, the output voltage and/or the intermediate circuit voltage; or
changing or modulating at least one DC voltage component in relation to a reference potential.

3. The method as claimed in claim 1, wherein:
the at least one DC voltage intermediate circuit has two nodes,
a circuit, including at least one load resistor of the one or more load resistors and a rectifying device coupled in series, is coupled between the two nodes poles, and
the system voltage is changed to cause:
a direction of the intermediate circuit voltage to be reversed,
the rectifying devices to become conductive, and
the at least one compensation current to flow through the rectifying device and the at least one load resistor.

4. The method as claimed in claim 3, comprising:
controlling a level of the excess power by controlling a duration of the reversal of the direction of the intermediate circuit voltage and/or a level of the intermediate circuit voltage.

5. The method as claimed in claim 1, comprising:
using at least two inverter devices connected in parallel with each other, the at least two inverter devices including the inverter device and being coupled via at least one load resistor of the one or more load resistors; and
changing respective system voltages of the at least two inverter devices differently from each other and causing the at least one compensation current to flow between the at least two inverter devices through the one or more load resistors.

6. The method as claimed in claim 1, comprising:
using a plurality of inverter devices including the inverter device, the plurality of inverter devices being coupled in parallel with each other and having a plurality of DC voltage intermediate circuits, respectively, the plurality of DC voltage intermediate circuits being coupled via the one or more load resistors, and
raising or lowering at least one inverter device of the plurality of inverter devices to a voltage potential and causing the at least one compensation current to flow through the one or more load resistors.

7. The method as claimed in claim 1, wherein:
a plurality of inverter devices are coupled in parallel, the plurality of inverter devices having a plurality of voltage inputs configured as AC voltage inputs,
the plurality of voltage inputs are coupled connected via the one or more load resistors, and
a voltage signal is modulated on at least one of the plurality of voltage inputs and a mean voltage shift is established with respect to a reference potential resulting in the at least one compensation current flowing through the one or more load resistors.

8. The method as claimed in claim 7, wherein:
the plurality of inverter devices are coupled with each other at respective DC voltage intermediate circuits of the plurality of inverter devices and the at least one compensation current or a portion of the least one compensation current flows back into the DC voltage intermediate circuits, and/or
the plurality of inverter devices are coupled with each other at respective voltage outputs of the plurality of inverter devices and the at least one compensation current or a portion of the at least one compensation current flows back in the voltage outputs.

9. The method as claimed in claim 1, wherein
the inverter device is coupled with a generator and/or consumer having a star point,
the one or more load resistors are coupled between the star point and a connection point of the DC voltage intermediate circuit, and
a voltage potential is changed to cause the at least one compensation current to flow through the load resistor, the star point and the generator or the star point consumer.

10. The method as claimed in claim 1, wherein
at least two inverter devices are coupled in parallel with each other and each inverter device of the at least two inverter devices is coupled to a generator and/or consumer having a star point,
the one or more load resistors are coupled between star points,
a voltage potential is changed and the at least one compensation current flows through the one or more load resistors, the star point and the generator or consumer, and
at least one of voltage inputs of the at least two inverter devices are configured as AC voltage inputs, a voltage signal is modulated on the at least one of the voltage inputs, and a mean voltage shift in relation to a reference potential results in the at least one compensation current flowing through the one or more load resistors between the star points.

11. The method as claimed in claim 1, wherein
at least two inverter devices are coupled with each other, wherein the at least two inverter devices each have respective DC voltage intermediate circuits as voltage inputs,
the DC voltage intermediate circuits are coupled in parallel and voltage outputs of the at least two inverter devices are coupled by the one or more load resistors, and
a voltage signal is modulated on at least one of the voltage outputs configured as an AC voltage output, and a mean voltage shift in relation to a reference potential results in the at least one compensation current flowing through the one or more load resistors between the voltage outputs.

12. The method as claimed in claim 1, wherein
a plurality of inverter devices are coupled in parallel with each other,
each inverter device of the plurality of inverter devices has a voltage output configured as an AC voltage output,
a respective output voltage is generated or influenced by a signal pulsed by switches at the voltage output,
switches of respective voltage outputs are controlled using switching times that are different and offset in relation to each another,
a differential potential is generated between voltage outputs of the plurality of inverter devices in response to controlling the switches, and
the differential potential causes the at least one a compensation current to flow through the one or more load resistors.

13. The method as claimed in claim 1, comprising:
changing the system voltage or changing the input voltage, output voltage and/or intermediate circuit voltage is varied over time in relation to a voltage level and/or a division between a plurality of inverter devices; or
in response to the system voltage of a subset of the plurality of inverter devices changing according to a predetermined criterion, changing the system voltage of at least one inverter device of the plurality of inverter devices to change an average system voltage of the plurality of inverter devices.

14. The method as claimed in claim 1, wherein
at least two inverter devices are coupled in parallel with each other, and
at least one additional consumer is coupled between at least two DC voltage intermediate circuits of the at least two inverter devices via a rectifier to cause the at least one additional consumer to be effectively coupled between a highest and/or lowest voltage potential of the at least two DC voltage intermediate circuits.

15. The method as claimed in claim 1, wherein the one or more load resistors are have a non-linear current-voltage characteristic curve.

16. An inverter arrangement, comprising:
at least one inverter device configured to generate at least one AC voltage and including
at least one voltage input configured to receive an input voltage;
at least one voltage output configured to output an output voltage;
at least one DC voltage intermediate circuit configured to provide an intermediate circuit voltage;
at least one load resistor configured to receive compensation current; and
a controller configured to control the at least one inverter device by at least:
controlling an AC voltage at the at least one voltage output to output a first portion of an input power as a supply power or receive the input power or a portion of the input power; and
changing a system voltage of the at least one inverter device such that the compensation current flows through the at least one load resistor to output a second portion of the input power to the at least one load resistor as excess power.

17. The inverter arrangement as claimed in claim 16, comprising:
at least two inverter devices each having a respective controller; and
a central controller configured to control the controllers of the at least two inverter devices.

18. The inverter arrangement as claimed in claim 16, wherein:
the at least one load resistor has a non-linear current-voltage characteristic curve.

19. A wind power installation, comprising:
the inverter arrangement as claimed in claim 16, wherein the wind power installation (100) is configured to:
feed electric power into an electricity supply grid using the inverter arrangement and dissipate the excess power using the at least one load resistor by changing the system voltage of the at least one inverter device.

20. The method as claimed in claim 6, comprising:
setting a plurality of voltage potentials of the plurality of DC voltage intermediate circuits to cause a voltage difference between the plurality of DC voltage intermediate circuits leading to the at least one compensation current flowing through the one or more load resistors, and/or
modulating a voltage signal on at least one voltage input of the plurality of inverter devices and causing a mean voltage shift resulting in the at least one compensation current flowing through the one or more load resistors, and/or
using the plurality of DC voltage intermediate circuits as respective voltage inputs to the plurality of inverter devices and modulating a voltage signal on at least one voltage input of the plurality of inverter devices and causing a mean voltage shift resulting in the at least one compensation current flowing through the one or more load resistors.

21. The method as claimed in claim 9, wherein a voltage signal is modulated on a respective voltage input configured as an AC voltage input and a mean voltage shift in relation to a reference potential results in the at least one compensation current flowing through the one or more load resistors.

22. The method as claimed in claim 13, comprising:
changing the system voltage or changing the input voltage, output voltage and/or intermediate circuit voltage such that the plurality of inverter devices are loaded evenly by compensation currents on average over time.
